(19) United States
(12) Patent Application Publication
(10) Pub. No.: US 2008/0023965 A1
(43) Pub. Date: Jan. 31, 2008

(54) Auxiliary power unit for transportation vehicle

(75) Inventors: Mario Cagliari, Pordemome (IT); Ennio Sartor, Fiume Vemeto (IT); Glenn Thomas Williamson, Reno, NV (US); Edward Patrick Picton, Reno, NV (US); Maria Lumpkin, Reno, NV (US); Edward Joseph O'Malley, Reno, NV (US)

Correspondence Address: Timothy D. Casey;Silversky Consulting LLC, 7570 Briargate Court, Reno, NV, 89523, US

(73) Assignee: BLACK ROAK SYSTEMS LLC, RENO, NV (US)

(21) Appl. No.: 11/493,495

(22) Filed: Jul. 25, 2006

(51) Int. Cl. H02K 7/18; F02D 31/00

(52) U.S. Cl. 290/1 B; 290/1 A; 290/1 R; 290/40 A

(57) ABSTRACT

An auxiliary power unit for providing power and HVAC to a vehicle. The auxiliary power unit is mounted to the vehicle in a variety of ways, but such that it can be readily moved away from the vehicle for service and maintenance. The power unit has a removable condenser and fan assembly that can be mounted to the power unit or remote from the human occupied portion of the vehicle. The power unit also including a programmable engine control unit for controlling and monitoring various aspects of the operation of the power unit and the vehicle. The power unit having a user interface that enables in-vehicle control of the engine control unit and remote control the engine control unit. The engine control unit monitoring when excessive power requirements of the power unit exists and limiting the air conditioning services of the power unit until the excessive power requirements no longer exists.

### BRIEF DESCRIPTION OF THE INVENTION

The present invention is related to systems for providing auxiliary power to long-haul trucks and similar types of transportation vehicles, and more particularly to a novel power unit that provides enough energy to supply concurrent loads, that does not need to actively interface with the main vehicle engine, that can be easily installed and maintained, that requires a minimal amount of space, that adds a minimum amount of weight to the vehicle, and that enables intelligent management of the power unit.

### BACKGROUND OF THE INVENTION

Transport trucks that haul goods over great distances in Europe, the Americas and other parts of the world are often referred to as long-haul trucks. In addition to a bed, the cabins of long-haul trucks are often configured to include microwaves, air conditioners, heaters, refrigerators, televisions, stereos and other electric appliances that require significant amounts of power. Long-haul trucks or big rigs will travel hundreds of miles in a day, over many days, often stopping only long enough to allow the driver to eat and take care of personal necessities and to rest and sleep, but when they do, many drivers want to use two or more of these appliances at the same time, such as an air conditioner, microwave, and television. Such conveniences are very important to many drivers, and given the increasing shortage of long-haul truck drivers, truck fleet owners are seeking new ways to attract drivers by providing a more luxurious cabin environment. Some trucking fleets have up to 100% turnover from year to year because the drivers are not satisfied with the life style provided by the fleet company. Yet, it costs a trucking company at least three thousand dollars to train new drivers, even if they have prior experience, so obviously, the quality of life of the driver is a key to success in the industry.

When a long-haul truck does need to stop, the driver might be able to do so at a truck stop, which is a specialized facility for providing fuel, maintenance, parking and convenience services. At other times, the trucks will stop wherever they can safely do so, such as at roadsides, rest stops and fueling stations. Although some truck stops provide auxiliary power tethers to the trucks, most drivers prefer to stop when and where it proves to be most convenient and to idle their main engines while stopped to provide power to the cabin of the truck. In the United States, a typical long-haul truck idles 2,500 hours per year, with the main engine consuming as much as 1.2 gallons per hour. As fuel prices increase, however, it is getting prohibitively expensive for drivers to idle the main engines for hours at a time. At a fuel cost of $3.25 per gallon, idling the main truck engine costs as much as $9,750 per year. Furthermore, many countries are instituting laws that make it illegal to idle a truck engine for extended periods of time to cut down on air pollution. Idling the engine for hours also decreases the amount of time between engine overhauls without increasing the productivity of the vehicle.

Accordingly, a number of companies have begun to supply auxiliary power units (APUs) to provide climate control and 120-volt power, to cut back on fuel consumption and air pollution, to reduce operating hours on the main vehicle engine, and to improve driver comfort and quality of life when on the road. A typical APU consumes about 0.2-0.3 gallons per hour, with significantly lower annual maintenance costs, thereby saving drivers/truck owners more than $6,900 per year in fuel costs alone. In the European Union, where long-haul trucks only idle about 1,800 hours per year, but fuel costs much more per gallon, the idle cost savings alone are over $8,500 per year.

The APUs currently on the market, however, share certain features and disadvantages. For example, most APUs use small diesel engines for power, but depending on the size of those engines, they may be able to provide only a limited amount of DC power and BTUs/hour for air conditioning and heating. Likewise, many of these engines are directly connected to the main engine so as to share main engine coolant, which can void warranties and prevent maintenance services from being available until the APU is removed. Some APUs do not provide for AC power because they do not include a generator, while others are noisy, cost too much to maintain, are too large or heavy, or do not provide for easy management and monitoring of the unit by the driver or the fleet owner. One of the biggest shortcomings of existing APUs is that they lack the ability to provide for concurrent power loads, meaning that drivers often have to manually shut off one electrical appliance or cooling/heating source when they want to use something else. In very cold or hot environments, this factor significantly detracts from the quality of the driver's life and therefore the attractiveness of the APU.

### BRIEF DESCRIPTION OF THE SEVERAL VIEWS OF THE DRAWING

FIG. 1 is a perspective view of the front and left side (when facing the APU from the side of the truck) of the APU in its service/maintenance position;

FIG. 2 is a perspective view of the back and right side of the APU with an environmental cover and co-located condenser and fan;

FIG. 3 is a perspective view of the back and right side of the APU with the environmental cover, but without the co-located condenser and fan;

FIG. 4 is a perspective view of the front and right side of the APU with the environmental cover and the optional step assembly;

FIG. 5 is a perspective view of the front and right side of the frame assembly illustrating a through-the-frame rail installation;

FIG. 6 is a perspective view of the front and right side of the frame assembly illustrating a frame rail bracket installation;

FIG. 7 is a perspective view of the front and right side of the frame assembly illustrating an installation for pre-drilled frame rails;

FIG. 8 is a block diagram illustrating the interconnection between the ECU, the ECU user interface, the main engine battery, the APU engine, and the cabin HVAC system;

FIG. 9 is a block diagram illustrating the interaction between the APU engine and the cabin HVAC system;

FIG. 10 is a plan view of the ECU user interface;

FIG. 11 is a flow chart illustrating the initial start-up operation of the ECU;

FIG. 12 is a flow chart illustrating some basic operations of the ECU user interface of FIG. 10;

FIGS. 13a, 13b and 13c illustrate additional displays corresponding to operational conditions for the ECU user interface;

FIG. 14 is a flow chart illustrating the battery monitoring operation of the ECU;

FIGS. 15a, 15b and 15c are flow charts illustrating the sensor monitoring operation of the ECU; and

FIG. 16 is a flow chart illustrating the load management operation of the ECU.

### DETAILED DESCRIPTION OF THE INVENTION

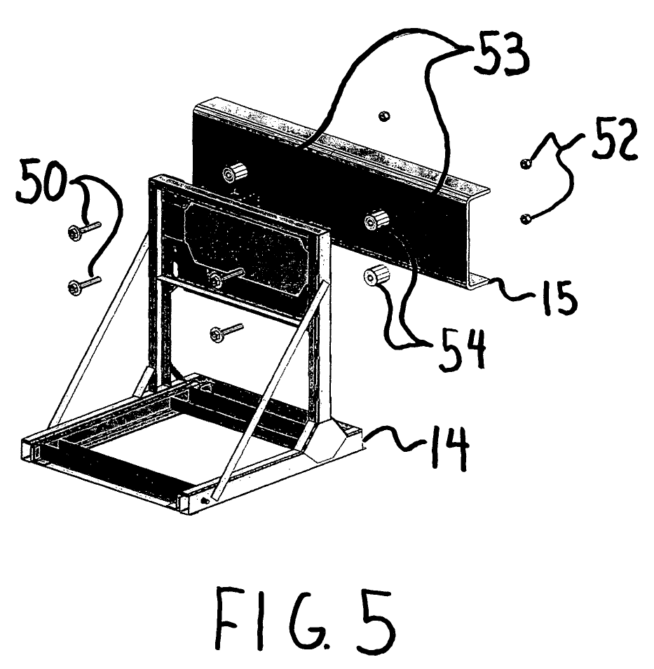

The present invention relates to auxiliary power units, and in particular to auxiliary power units for long-haul trucks. In the preferred embodiment of the present invention, the auxiliary power unit (APU) has a lateral dimension of up to approximately 62 centimeters or 24.5 inches, which is small enough to enable it to be mounted in a variety of positions behind the cabin of the truck without interfering with or taking away space from other components of the truck, although APU's of many different sizes could also be utilized in a similar fashion. Typically, the APU would be mounted close to the truck cabin on one of the two frame rails of the truck, as illustrated in FIGS. 5, 6 and 7, but the APU could also be mounted between the frame rails or to some other part of the truck.

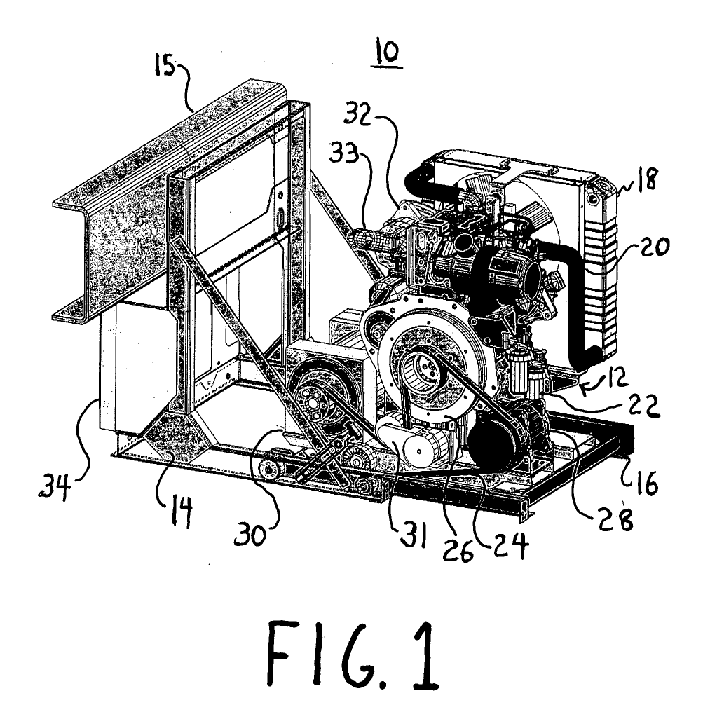

Mounting the APU to one of the frame rails provides a very stable mounting environment for the APU due to the structural integrity of the frame rails. This mounting environment also enables easier installation and access to the APU for maintenance and service. Mounting the APU close to the cabin can reduce the cost of the installation by reducing the length of the umbilical cord (described further below) between the APU and the truck cabin where the main controller for the APU is located. In the preferred embodiment of the present invention, a frame rail mounted APU is disclosed that facilitates access for maintenance and service, as further illustrated in FIGS. 1-7.

FIG. 1 is a perspective view of the front and left side of APU 10 when viewed facing the side of the truck to which the APU 10 is mounted. The APU 10 includes the APU engine 12, which is a two or three cylinder diesel engine mounted to a frame assembly 14, which includes a sliding component 16. The frame assembly 14 is attached to the frame rail 15 of the truck, but the sliding component 16 enables the entire diesel engine 12 to be pulled away from the truck and easily accessed by anyone needing to service the engine.

FIG. 1 illustrates the APU engine 12 when the sliding component 16 has been pulled away from the frame assembly 14, such as when it is being serviced. In order for the engine 12 to be pulled away from the truck on the sliding component 16, certain mechanical and electrical components need to be designed to facilitate this type of movement without breaking down over a number of years, such as the electrical wiring, hoses, exhaust pipes and other similar components. For example, the electrical wiring between the APU 10 and the truck cabin is provided through a spring-shaped umbilical cord consisting of power wires and communication wires. The spring shape of the cord enables it to stretch out when the APU is pulled away from the truck for service, and to shrink back into a smaller size when the APU is in its normal operating position, all without putting undue stress on the wires within the cord. Likewise, the exhaust pipe is connected with a flexible metal hose and a quick-fit connector, rather than welded in place.

As noted, the APU engine 12 is typically a two or three cylinder diesel engine capable of generating approximately 10-30 horsepower at varying revolutions per minute, such as the Yanmar™ TNV Series-1 engines, although other types and sizes of engines could be utilized. A diesel engine of the indicated power is preferred due to environmental concerns (reduced emissions and noise), economics (better fuel economy while providing more than adequate power) and driver convenience (most long-haul trucks utilize diesel engines, thereby allowing the main engine and the APU to be fueled at the same time). Also, most truck owner/operators prefer to link the APU to the main gas tank(s) for the truck, rather than carry an additional tank for the APU, so using common fuel under such circumstances is essential. It would be preferable, obviously, to provide a separate storage tank for the APU, if the APU engine 12 used a fuel that could not be used by the main truck engine, although this would add significantly to the cost of installing the APU.

As illustrated in FIG. 1, some of the major visible components of the engine 12 include a water/coolant radiator 18, an air cleaner 20, and fuel filters 22 on the right-hand side of the engine. At the front of the engine 12, driven by the serpentine belt 24 are the engine flywheel 26, the air conditioning compressor 28, the AC power generator 30, and the belt tensionor 31. The DC power alternator 32 is shown on the back left-hand side of the engine 12, as is the exhaust pipe 33.

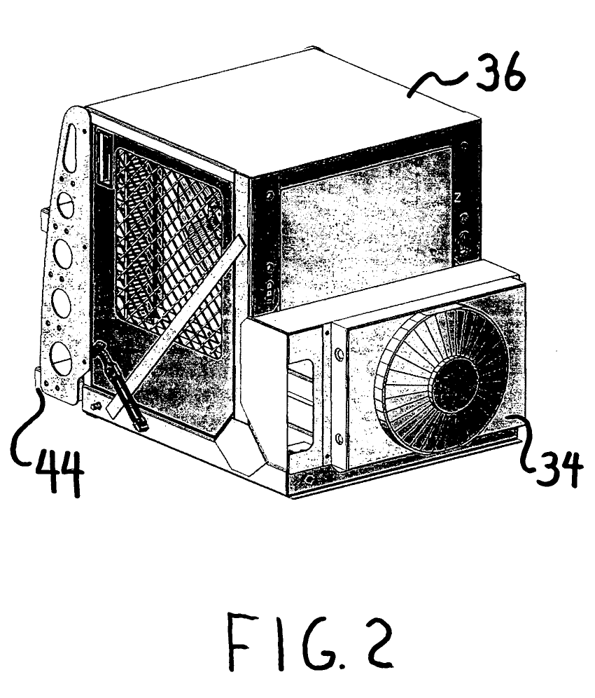

As further illustrated in FIG. 1, the backside of the air conditioning condenser and fan 34 is shown. A perspective view of the front and right side of the condenser and fan 34 is illustrated in FIG. 2. The condenser and fan 34 need not be co-located with the engine 12, if space in the area of the APU installation is at a premium, or if the owner/operator prefers to move the condenser and fan 34 as far away from the truck cabin as possible so as to reduce noise inside the cabin.

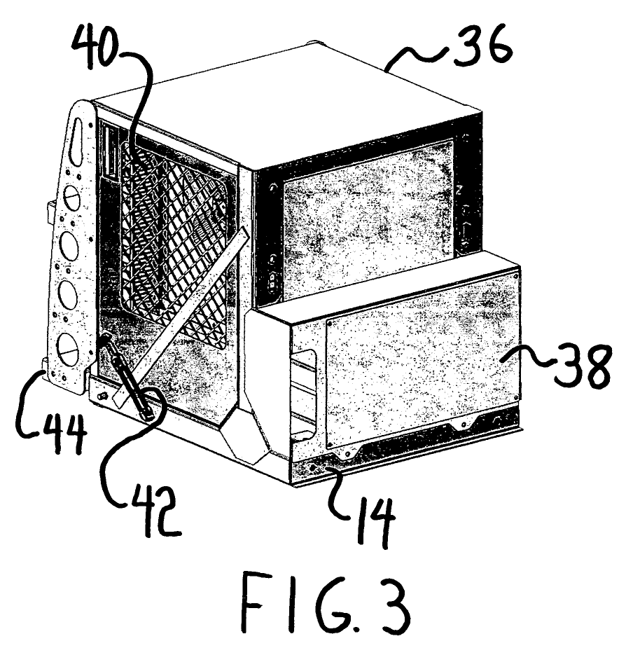

In such cases, as illustrated in FIG. 3, the condenser and fan could be removed from the frame assembly 14, with the resulting opening being covered by the plate 38. The coolant lines from the compressor 28 would then be run to wherever the condenser and fan had been relocated in order for the air conditioning system to operate properly. The condenser and fan 34 works in conjunction with the compressor 28 to provide approximately 26,000 BTU/hr of air conditioning for the cabin of the truck when the APU 10 is being utilized in place of the truck's main engine. The generator 30 is configured to provide between 3.7 Kw to 6.0 Kw of AC power, while the alternator 32 is configure to provide approximately 55 Amp of DC power, although different levels of cooling and power could be configured.

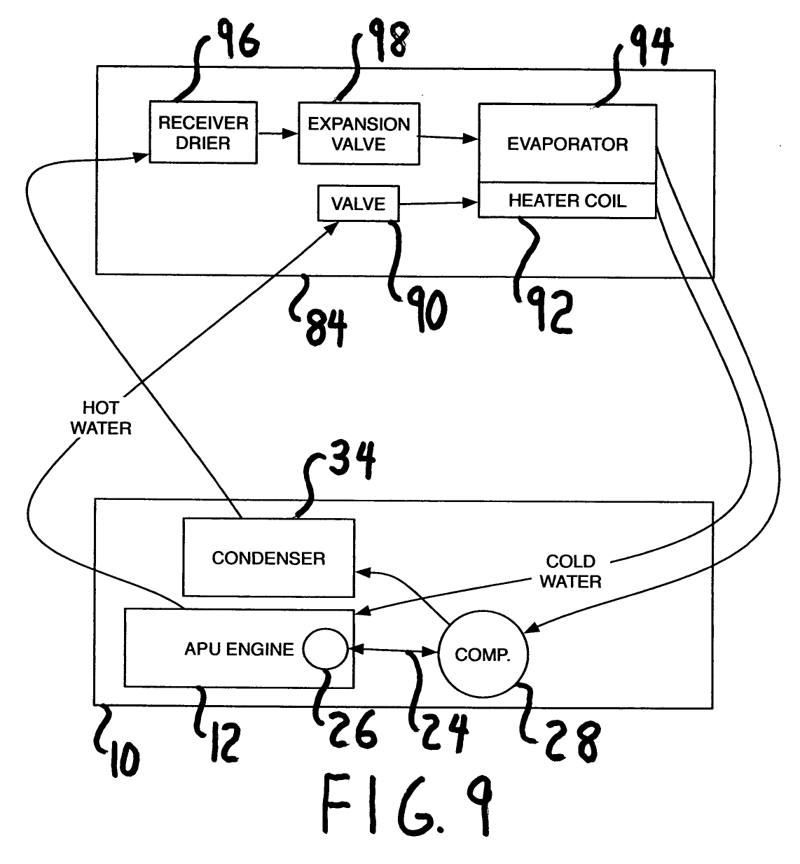

In the preferred embodiment of the invention, the cabin is also provided with approximately 26,000 BTU/hr of heat through use of heated coolant from the radiator and a heater core. Heat for the engine 12, for starting and running in cold climates, is provided by a block heater. In FIG. 9, the interaction between the APU engine and the cabin HVAC system will be further described. Also, as further described below with respect to the ECU, air conditioning and heating (HVAC) can be automatically or manually controlled.

FIGS. 2 and 3 also illustrate the APU 10 covered by its environmental shell 36, which further reduces the level of noise produced by the APU engine 12. FIGS. 2 and 3 show the APU 10 as positioned in its normal operating position. The environmental shell 36 provides protection to the APU engine 12 when the truck is on the road, while allowing sufficient air to move through the shell, such as through screen 40. A variety of different shells could be used depending on the owner of the truck and the location of the APU 10. Owner operated trucks that have the APU 10 installed in a visible location may want a visually appealing cover, such as diamond plate metal or chromed metal. When the APU 10 is not visible, or the owner of the truck is less concerned with appearance, a less expensive thermoplastic (or similar type of material) could be used.

As previously noted, sliding component 16 of the frame assembly 14 enables the entire APU engine 12 to slide out from its operating position on the rollers of the sliding component 16 when it is necessary to maintain and service the APU 10. To prevent the APU engine 12 from sliding out during operation, the sliding component and engine need to be locked into position, using bolts or some similar form of fixation. The bolt heads should preferably be located at the front of the APU so they can be easily accessed and removed when maintenance or service is required. The environmental shell 36 could also be bolted down, or the tie downs 42 on either side of the shell, connecting the frame assembly 14 to the environmental shell 36, could be utilized to provide a quick release mechanism for the shell.

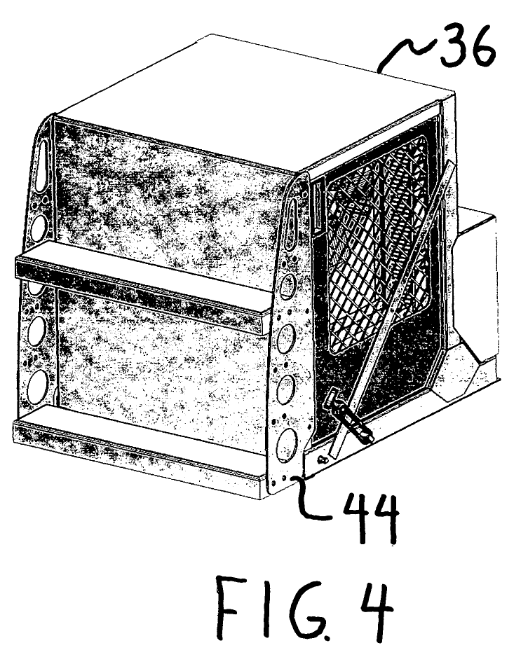

FIGS. 2 and 3 further illustrate a step assembly 44 that could be affixed to the APU 10, which is better illustrated in FIG. 4. The step assembly is optional, but when provided, enables someone to climb the steps on the APU 10 to get on top of the APU 10 or the upper portion of the truck.

As previously noted, in the preferred embodiment of the present invention, the APU 10 is mounted to the frame rail 15 of the truck. FIGS. 5, 6 and 7 illustrate three ways in which such mounting is achieved. In FIG. 5, the frame assembly 14 is affixed to the frame rail 15 by a series of bolts 50 and nuts 52. The bolts 50 are inserted into holes 53 that have to be drilled through the frame rail 15 for the purpose of mounting the APU 10. In some applications, it may be desirable to distance the frame assembly 14 from the frame rail, for example to provide extra space for the condenser and fan 34 when that item is mounted to the APU 10 instead of in a remote location. In such cases, different length spacers 54 could be utilized between the bolts 50 and nuts 52. When utilizing spacers 54 to create additional space for the APU 10, caution must be exercised to prevent the APU 10 from extending too far away from the side of the truck, lest it collide with another object when the truck passes by that object.

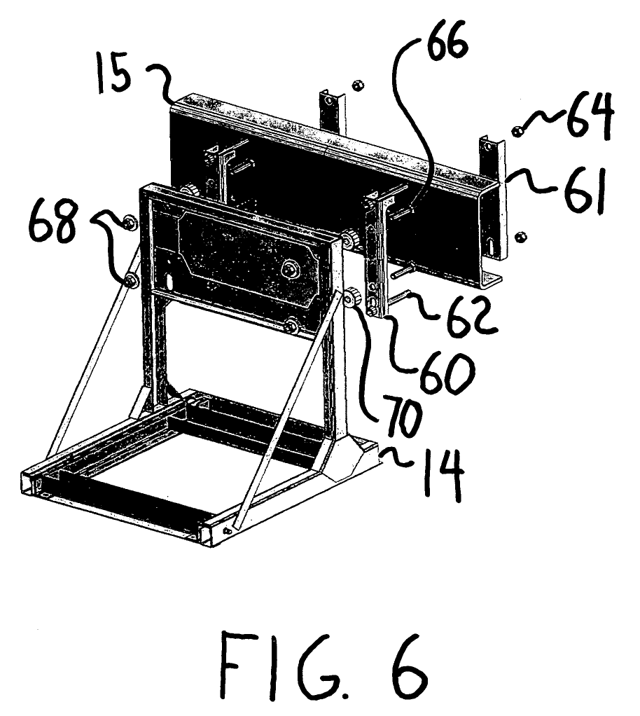

Some truck owners object to drilling holes in the frame rails out of concern for the structural integrity of the rails or due to a general unwillingness to make any permanent alteration to the truck's body. For fleet operators, business arrangements regarding the ownership and/or financing of the trucks can lead to long delays and special permissions being required in order to drill holes in the frame rails. In such cases, the bracket arrangement illustrated in FIG. 6 can be utilized. As shown in FIG. 6, a front bracket 60 is attached to a rear bracket 61, with the frame rail 15 situated in-between the brackets, by bolts 62 and nuts 64. The frame assembly 14 is then affixed to the front bracket 60 by the bolts 66 and the nuts 68. As discussed in FIG. 5, spacers 70 could also be utilized to provide extra space for the APU 10. A wide variety of different means of attaching the frame assembly 14 to the frame rails 15 or the truck could also be utilized.

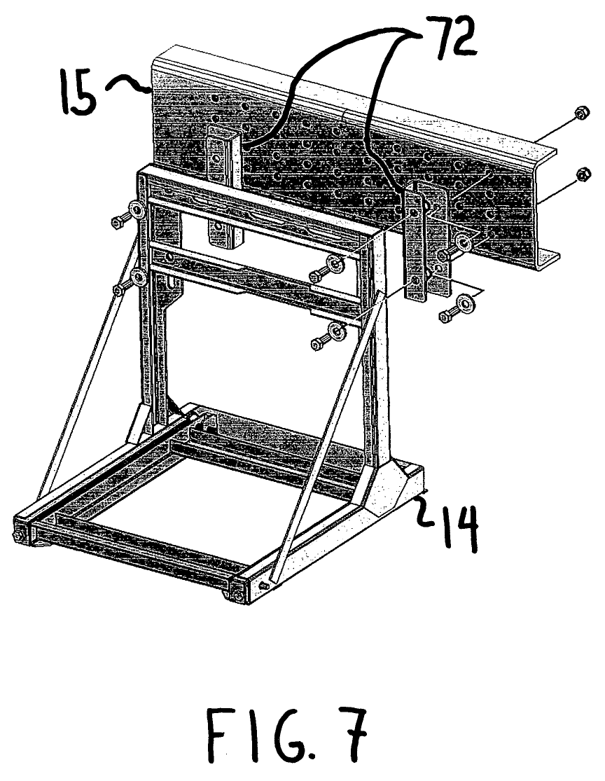

In many European countries, the frame rail 15 of the truck is pre-drilled with holes for a number of different reasons, including mounting accessory equipment such as an APU. FIG. 7 illustrates an example of a pre-drilled frame rail 15, where the pre-drilled holes do not necessarily line up with the mounting components of the frame assembly 14. In such a case, conversion brackets 72 would be utilized to form an interface between frame assembly 14 and the frame rail 15. For example, the frame assembly 14 would be bolted to one side of bracket 72, with holes in that one side of the bracket designed to line up with holes in the frame assembly 14, while the other side of bracket 72 would be bolted to the frame rail 15, with holes in that other side of the bracket designed to line up with holes in the frame rail 15.

The APU 10 and other aspects of the invention are controlled by an engine control unit (ECU) or engine management system (EMS), which is a microprocessor controlled electronic device that enables programmed or external control of the APU engine 12 and other electronically controlled components. ECU's are commonly used to control vehicle engines and are well known in the art. The ECU includes a variety of electrical components on a printed circuit board, including the aforementioned microprocessor that processes inputs from the engine sensors in real time and controls the hardware (including all of the electro-optical components of the APU, including the in-cabin HVAC system) in accordance with operator inputs and/or programmed instructions in the form of software or firmware. The typical ECU of an engine can read many different sensors associated with the engine and use that information to control various aspects of the engine's operation. This might include the ignition systems of the engine so as to improve fuel efficiency, regulate power, and lower pollution levels. The ECU can also compensate for many engine operation variables, such as ambient temperature, humidity, altitude, and fuel octane ratings.

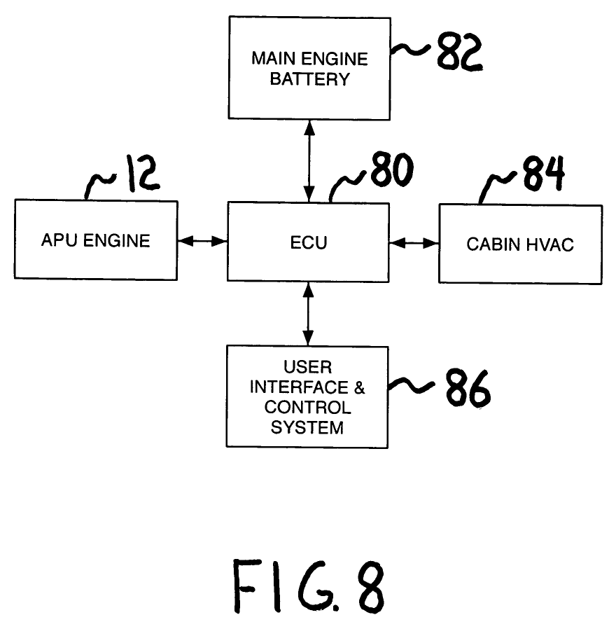

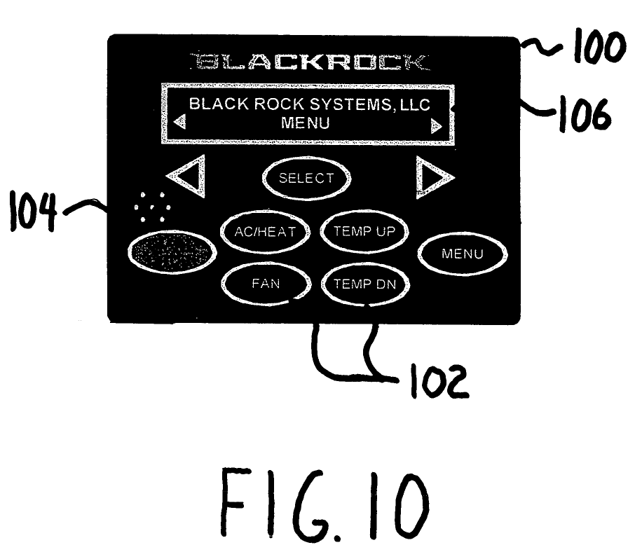

As shown in FIG. 8, with respect to the present invention, the ECU 80 is utilized to control various operational aspects of the APU engine 12, as well as the main engine battery 82 of the truck, and the truck's in-cabin HVAC system 84 associated with the APU. The ECU 80 is in turn partly or fully controlled by the ECU user interface and control system 86. Preferably, the ECU user interface and control system 86 is multifunctional, depending on who is using it and how the various interfaces to the control system 86 are provided. For example, the control system 86 can have an electro-mechanical user interface in the cabin of the truck that can be accessed by the driver of the truck. This type of user interface for the control system 86 utilizes a simple visual display or electronic touch screen and/or a series of basic tact switches that allow the truck driver to control some basic functions of the APU 10 through the ECU 80. An example of a user interface with an alphanumeric display and tact switches is further illustrated in FIG. 10. Since many truck drivers are older and less comfortable with electronic interfaces than many younger drivers, they may prefer toggle switches, rotary switches and encoders, which are the switches typically utilized in modern automobiles and trucks used to control radios and heating/cooling systems.

In addition to the electro-mechanical user interface, one or more additional types of interfaces, such as a USB interface, are preferably provided, with any and all types of user interfaces being referred to herein as a user interface unless otherwise stated. The advantage of the USB interface is that it will enable direct and remote connection of a computer to the ECU 80. A directly connected computer could be utilized when performing maintenance and service on the truck, or when first installing or upgrading the APU 10. Remote computer connections, for example, through a wireless Ethernet connection to the ECU 80, would provide long-range remote diagnosis and maintenance on the APU 10, as well as computerized setup, upgrade, testing and diagnosis of the APU 10. Additional wireless connections could be provided through an Internet connection, a Bluetooth connection or even through a cell phone network. Drivers could even be provided with some sort of wireless remote control device, like for a television set, which would enable them to perform simple operations while sitting in a diner near their truck.

While the driver's user interface might be structured to only allow the driver to control some very basic operations, such as turning the APU on and off, setting the temperature for the air conditioning or heating within the truck cabin, turning a fan on or off, and perhaps checking on certain basic maintenance items, such as whether the APU is in need of oil, computer-based user interfaces could provide a broader range of control options. Irrespectively of the control means, all such control devices would perform certain similar functions, such as setting operating times and conditions, and providing input/output data associated with usage, service and support information.

The broader range of access and control provided by remote computers enables some unique features associated with the APU 10. For example, a different level of access could be provided to a truck owner (other than the driver) or to fleet operator, thereby enabling the owner/operator to monitor the truck, the APU 10 and to control both to some degree. The owner/operator could limit the high or low temperatures that could be selected by the driver, or the amount of time the APU is allowed to run, or perform system checks to make sure the APU is not in need of service or maintenance. Likewise, the owner/operator could set certain controls that could not be overridden by the driver (or only overridden in case of emergency with the proper code), such as when the APU is turned on. For example, some drivers may not want to use the APU, preferring instead to idle the main truck engine, but the owner/operator might want the APU used instead to save money and to cut down on the operating time of the main truck engine. In some fleet trucks, the owner/operator may even prefer to prevent the driver from having any control over the APU through a user interface at all, leaving all such control for preprogrammed operation or remote control by the fleet operator.

The driver/owner/operator could program the APU to turn on and off at scheduled times, such as turning the APU on for one hour every morning when the truck is not in use. In other cases, the owner/operator could use the programming of the APU to control the driver. For example, the owner/operator could set the APU user interface 86 to turn the APU 10 on after the truck has idled for more than five minutes, to see whether the main truck engine is still running, and if necessary to turn off the main truck engine. Providing a wiring connection to the ignition of the truck and the truck's main battery would readily enable this function. Monitoring the battery would tell the owner/operator whether the main truck engine was still running, thereby enabling the owner/operator to remotely kill and disable the ignition of the truck.

As previously noted, remote control of the control system 86 would also enable the owner/operator to perform less nefarious activities, such as monitor oil and coolant levels, perform other diagnostics, perform remote upgrades and maintenance, etc., or to even communicate with the truck driver through the in-truck user interface. Diagnostics provided by the ECU would include various fault codes that correspond to typical engine faults that can either be stored in a log when they occur or remotely transmitted to a central control facility while the truck is on the road. Usage patterns could also be recorded or transmitted to enable fleet operators to facilitate budgeting and planning, or to prevent overuse or abuse. Any of these different levels of control would be associated with different levels of access, such as through a user name and password, such that the driver would have one level of access and control, the operator a second level of access and control, the owner a third level, and the manufacturer or service provider for the APU a fourth level.

The driver and/or the owner/operator could also utilize the thermostatic temperature control features of the system so as to automate the temperature of the cabin, such as setting it at 72 degrees no matter what the external conditions might be. Likewise, thermostatic control could also allow the driver to set different temperature settings for different times of the day, such as when he/she first gets up, during normal operating times, or when the driver goes to bed.

To better explain the temperature control features of the APU, reference is now made to FIG. 9, where the cabin HVAC system 84 is explained in detail. The cabin HVAC system 84 is part of the APU 10 and is located within or in close proximity to the cabin of the truck so that it can efficiently transfer hot and cold air into the cabin as required. It is important to note that the APU 10 of the present invention is “passive” to both the main engine of the truck and to the HVAC system associated with that main engine. In other words, the APU 10 (including the HVAC system) does not rely upon any major subsystem or component of the main truck for operation, such as the coolant, refrigerant and oil lines, the HVAC system, the electrical system, etc. The APU 10 can be configured to connect to the truck's electrical system to provide back-up power and recharge of the truck's battery or to kill the truck's engine, but the APU 10 does not rely upon any such connection for its own operation.

To provide heat to the cabin of the truck, hot water is routed out of the radiator of the APU engine 12 to an electro-mechanical valve 90 within the cabin HVAC 84 and then to a heater coil 92. A blower fan, not shown in FIG. 9, blows air through the heater coil and into the cabin of the truck to provide heat. Control of heat within the truck is controlled by the valve 90, which is in turn controlled by the user interface and control system 86. When a higher temperature is selected by the driver (or remotely) using the control system 86, the valve 90 is opened further. Likewise, when a lower temperature is desired, the valve 90 may be further closed, or the fan speed could be lowered.

In extremely cold climates, such as Alaska, parts of the United Stated, Canada and Europe, an additional heating feature might be required to warm the engine. Inserting an electric heater inside the radiator coolant hose of the APU engine 12 provides this feature. Providing power to the electric heater heats the coolant within the hose and makes it easier for the engine of the APU to start in cold weather.

The cabin HVAC system 84 provides air conditioning within the cabin of the truck in a similar fashion. The APU engine 12 drives the engine flywheel 26, which is connected to the air conditioning compressor 28 by the serpentine belt 24. The air conditioning compressor, which is basically a pump, is responsible for compressing and transferring refrigerant gas to the condenser 34. The intake or suction side of the compressor 28 draws refrigerant gas from the outlet of the evaporator 94, further explained below. That refrigerant gas is then compressed and sent to the condenser 34, where it can transfer the heat that is absorbed from the inside of the vehicle.

The condenser 34 is like a radiator. It is designed to radiate heat. As previously noted, it can be located in a variety of different locations relative to the APU engine 12 so as to improve air flow through the condenser 34 and to reduce noise from the condenser fan near the cabin of the truck. As hot compressed gasses are introduced into the condenser 34, they are cooled off. As the gas cools, it condenses and exits the condenser 34 as a high-pressure liquid. This high-pressure liquid is then routed to the receiver-drier 96, which is designed to separate gas and liquid and to remove moisture and filter out dirt from the refrigerant. The refrigerant is routed from the receiver-drier 96 to the electro-mechanical expansion valve 98, which can sense both temperature and pressure and can therefore be used to regulate the flow of refrigerant to the evaporator 94. Hence, to control the air conditioning within the cabin of the truck, the ECU 80 regulates the operation of the expansion valve 98 through the controls specified by the user interface and control system 86.

The evaporator 94 serves as the heat absorption component of the cabin HVAC system 84. Its primary duty is to remove heat from inside the cabin and to dehumidify the air inside the cabin. As warm air is sucked out of the cabin by the fan (not shown), it travels through the aluminum fins of the cooler evaporator coil, the moisture contained in the air condenses on its surface. And, as refrigerant enters the evaporator and warm air passes through the evaporator fins, the refrigerant boils, causing it to absorb large amounts of heat, which is then carried off with the refrigerant to air conditioning compressor 28. As the heat is absorbed from the air blowing through the evaporator that air is cooled and in return blown back into the cabin of the truck.

As previously noted, the ECU 80 is controlled through operation of the user interface and control system 86. FIG. 10 illustrates an example of an in-truck user interface 100. So as to reduce environmental stress and in order to consolidate the location of the various aspects of the control system 86 and the ECU 80, these two components would be preferably collocated, and referred to herein collectively as the control system 86, within the cabin of the truck in a chassis of some type. The control system 86 would be contained within a plastic or metal box that would be mounted in a convenient location somewhere within the cabin of the truck, and connected to the APU engine 12, the cabin HVAC 84 and the other components of the APU 10 through various wires, although wireless interconnections could also be utilized. The ECU could also be mounted within a separate box somewhere within the cabin and inaccessible to the driver.

Within either the ECU box or the control system box, would be the microprocessor or controller of the ECU that would interface to the user interface 100. This user interface would preferably be mounted to the front of one of the boxes within the cabin and be comprised of a series of buttons 102, a speaker 104 and a display panel 106. The buttons 102 enable the user to scroll through a series of displayed instructions or results and to make necessary selections. The buttons 102 also enable the user to start and stop the APU engine 12, select air conditioning or heating, control a fan, turn the temperature in the cabin up or down, and access a main menu system on the display 106. As previously noted, many different types of controls can be utilized in place of buttons, such as dials, knobs, and a wide variety of switches. As shown in FIG. 10, the buttons 102 are tact switches that provide a small amount of tactile feedback to the user when operated. Additional feedback could be provided in the form of some tone or audible message to the user to indicate that a button 102 has been fully depressed when making a selection. This tone would be routed through the speaker 104.

One of the buttons 102 on the user interface 100 is the start/stop button, which is used to turn the APU engine 12 on and off. When the APU is not running and the start/stop button is selected, the APU engine 12 will be started, and vice versa, when the button is selected when the APU engine 12 is running, then the APU engine will be stopped. However, before the APU engine can be started or stopped through control of the user interface 100, the ECU needs to be running. Normally, the ECU is booted up when power is provided to the APU system, such as through a battery or through the truck's electrical system.

To enhance the functionality of the APU 10 in many different markets around the world, the ECU is preferably power universal, in that it will operate with different electrical systems, such as 12 volt DC and 60 Hz and 120 volt AC systems in North America and 24 volt DC and 50 Hz and 220 volt AC systems in other parts of the world. To achieve this feature, the ECU would need to be able to sense when the input power to the ECU changes so the ECU can operate in either environment without having to have different ECUs.

The control system 86 would also preferably include a real time clock that would enable timed runs of the APU, the current time to be displayed on the display 106, the APU engine hours to be tracked for maintenance purposes, and for time-stamped logs to be created. The time-stamped logs could be used to log events such as failures, warnings, run time intervals, telemetry, etc. The control system 86 would also preferably include a means of connecting the J1939 bus that is common to most modern tractor/trailer trucks. This bus controls various sub-systems within the truck and could be used by the APU 10 to likewise interface with and control these same systems, such as the running of the main truck engine, the recharging of the battery, etc.

As previously noted, the APU 10 could receive power from a battery, such as the main truck engine battery or a separate battery just for the APU 10. Likewise, a backup battery could be provided within the control system 86 box to keep the ECU and the clock running even when power is lost from the other batteries on the truck. When power is provided to the ECU, it will perform a boot up operation 110 similar to that illustrated in FIG. 11. In the first step 112, the program or programs for the ECU are loaded into its computer processor.

Once these programs are loaded, the display 106 would display some type of display, step 114, such as the one shown in FIG. 10, to allow an operator to know that the ECU has booted up and is operational. A bleep or similar type of tone might also be provided through the speaker 104. A different, but similar, display and tone might be provided if a computer or other type of device was controlling the ECU remotely. The ECU would also start a number of internal monitoring subroutines or threads, such as the FET sensor monitoring thread 116 and the battery monitoring thread 118. Once these processes have been started, the system would check to make sure the APU was running, step 119, and exit to the main mode of operation to figure out what to do next, step 120.

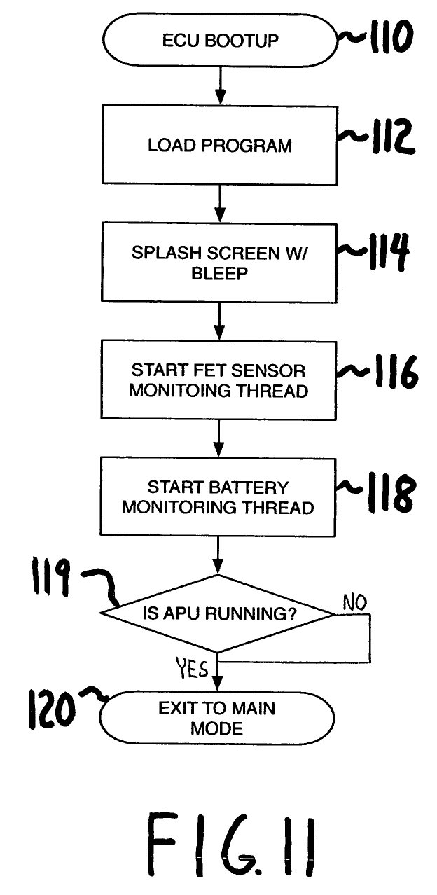

FIG. 12 is a flow chart illustrating the basic operation of the user interface 100, including typical display screens that are displayed during the ECU's operation. When the ECU is booted up and processes to step 119, or when the ECU is activated from its sleep mode, the ECU shifts to its main mode of operation, step 120. In the main mode, the ECU 84 first determines whether the APU 10 is running, step 119, as previously illustrated in FIG. 11. If it is not running, the display 106 will indicate that the APU 10 has stopped and will indicate the total amount of time the APU 10 has run since last serviced, step 122. Instead of indicating when the APU 10 was last serviced, other types of displayed information is also possible, such as when the APU 10 was stopped, how many total hours it has run since last overhauled, etc.

If the user does not press one of the buttons 102, as shown in FIG. 10, then the display will remain at step 122 until the APU 10 is started. If the user presses either the left or right arrow buttons on the display 106, then the display will toggle through additional displays. For example, pushing the right arrow button will cause the display to show the time and date, step 124. The time and date illustrated in FIG. 12 is for illustration purposes only and is not intended to represent an operational date of the present invention. Pushing the right arrow button again will cause the display to show the maintenance that is currently required, if any, step 126. Likewise, when at step 122, pushing the left arrow button would have caused the display to toggle to step 126, and if pushed again, then step 124, and again, then step 122, etc.

If the APU 10 is running at step 119, then the display will indicate the APU 10 is running, and indicate the number of hours it has run since last serviced (when reset), step 128, or some other indication of time as indicated above. After a predetermined period of time, or when the right arrow button is pressed, the display 106 would toggle to the next display, step 130, which shows the current coolant temperature. In time, or upon selection of the right arrow button again, the display would show the oil pressure in pounds per square inch (psi), step 132. Subsequent displays include the generator voltage and frequency, step 134, the time and date, step 136, any warning signals, step 138, and any required maintenance, step 140. Warnings and maintenance displays could also be the default displays illustrated when any failure has occurred or any maintenance is required. For example, if the APU 10 is running, the first display could be the warning display, step 138, so the user immediately knows that a failure has occurred, such as the alternator failing to charge. Usage of the left arrow button could likewise cause the displays to toggle between each of the displays from steps 128-140.

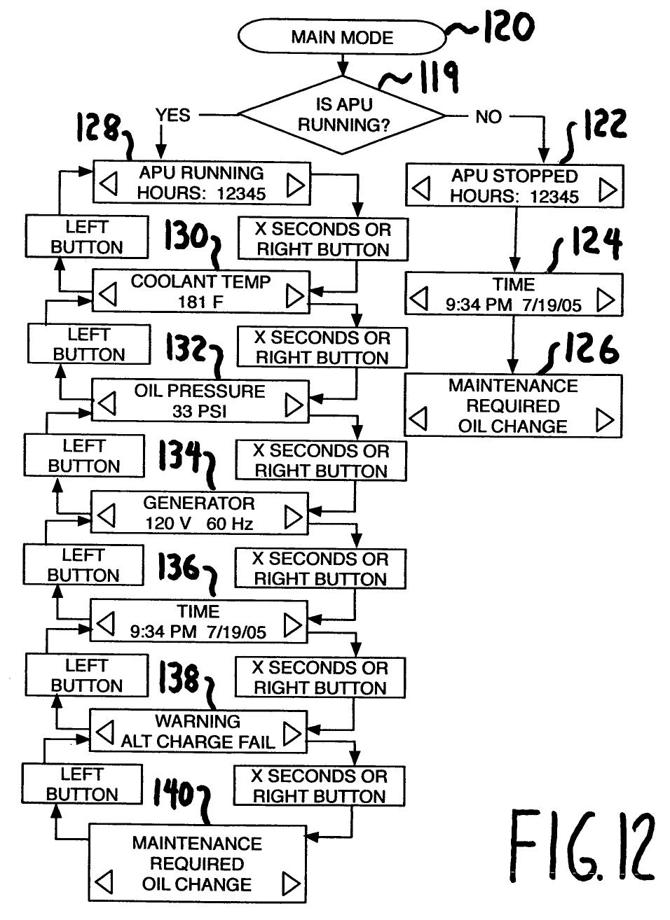

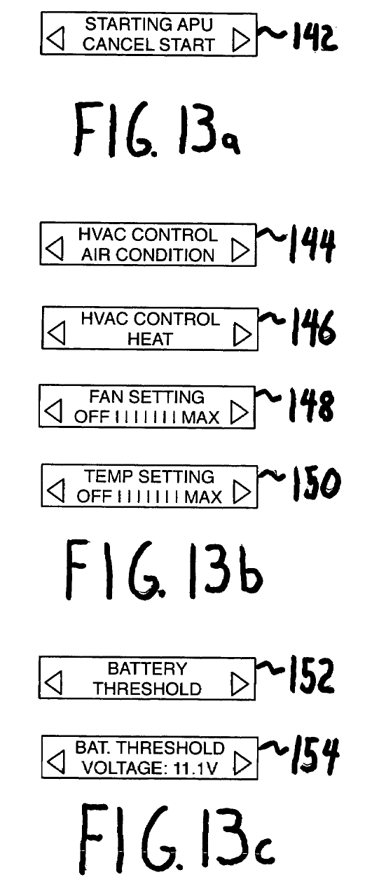

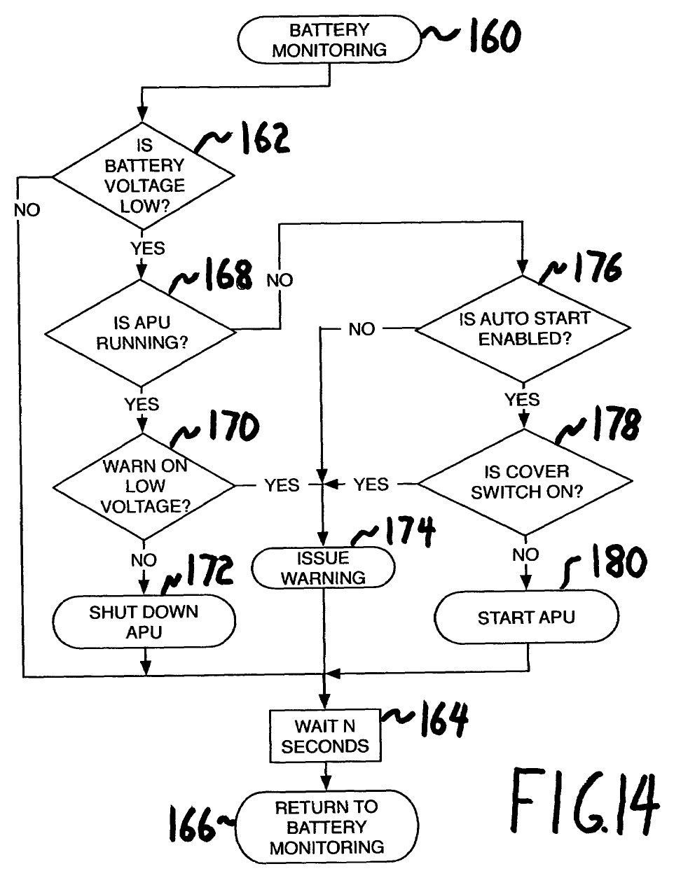

FIG. 12 is only representative of what some of the displays for the user interface 100 could be and how this user interface 100 could operate, but it need not include these exact displays or operate in just the manner illustrated above. As previously noted, if the user interface is connected to an external computer, many additional controls and therefore display options would be available. Irrespective of the user interface utilized to interact with the control system, some of the likely additional displays would include those illustrated in FIGS. 13a-13c. FIG. 13a illustrates a display 142 that would be provided when the APU engine 12 is in the process of being started. Selection of the appropriate arrow button among buttons 102 would either result in this operation being canceled or the APU being started.

FIG. 13b illustrates some of the additional displays that would be provided while operating the cabin HVAC system. For example, when the AC/Heat button among buttons 102 is pressed, the display would toggle between display 144 for air conditioning and display 146 for heat. Pushing the select button while either of these displays is on the display 106 would cause the corresponding HVAC function to be selected. Likewise, selection of the fan button would generate the fan setting display 148, while selection of the Temp Up or Temp Down would generate the temperature setting display 150.

FIG. 13c illustrates additional displays associated with control of the battery charging functions of the APU 10. Display 152 would be displayed when the user was attempting to determine or set the charge threshold for the battery. Display 154 would likewise be displayed to show the user where the voltage threshold was set. As these displays indicate, an additional function of the APU 10 is to provide back up charging support for the main battery of the truck. One of the most common assistance calls received from big rig trucks is for a dead battery. Batteries may discharge overnight when the truck is parked because a light is left on within the cabin, or for many other reasons. When the APU 10 is installed, dead batteries can be avoided through use of the battery monitoring functions of the ECU 80. It should also be noted that the APU 10 could be utilized as a stand-alone power source for emergency use and similar types of situations. To be utilized in this manner, it would be necessary to interface the power generation functions of the APU 10 with the external device to be powered. Preferably, the APU 10 is configured to easily allow such interface.

As previously noted with reference to FIG. 11, step 118 initiates a subroutine or thread that monitors the battery of the truck, or any other battery that might be installed on the truck, including the battery for the APU 10. As illustrated in FIG. 14, initiation of this thread, step 160, provokes the ECU 80 to determine if the battery voltage is low, step 162. Obviously, if multiple different batteries were being monitored, this step 162 may be asked for each battery independently, or different battery monitoring threads could be run for each battery. Irrespective of the battery being checked, if the battery voltage is not low, the subroutine will move to step 164 to wait for some N period of time and then return to step 160 to start the monitoring process again, step 166.

If the battery voltage is low in step 162, the ECU 80 will then check to see if the APU 10 is running, step 168. If the APU 10 is already running and the battery is low anyway, there is a high probability that something else is wrong with the APU 10 or the battery, which could be handled by the ECU 80 in a number of different ways. The ECU could simply shut the APU 10 down until the problem was investigated and resolved. Alternatively, the user could select a different approach that first provides a warning to the driver before doing anything else. Hence, in step 170, if the APU 10 is running and the user has not set a warning for when the battery voltage is low, the ECU shuts the APU 10 down, step 172.

If the warning on low battery voltage has been selected, however, the ECU will issue a warning, step 174, that is appropriate for that condition, such as “Low Battery Voltage,” on the display 106 of the user interface, before moving on to step 164 and returning to the beginning of the thread, step 166. If back at step 168 it was determined that the APU 10 was not running, then a different approach could be taken. In this case, if desired, the user could have selected an auto start option that would cause the APU 10 to automatically start under such conditions. If the auto start feature is enabled, step 176, the ECU 80 would first check to make sure that the cover switch was not on, step 178, and if it was not, then it would start the APU 10, step 180. The ECU checks to make sure that the cover switch is not on as a safety precaution because the cover switch is only on when the cover 36 of the APU engine 12 is open. Obviously, it would not be desirable to have the APU engine 12 automatically started while the cover is open and someone is performing maintenance on the APU engine 12 or some other component of the system, such as a fan. If the auto start feature is not enabled, the ECU 80 might just issue a warning that the battery voltage is low, step 174, and restart the process, step 166.

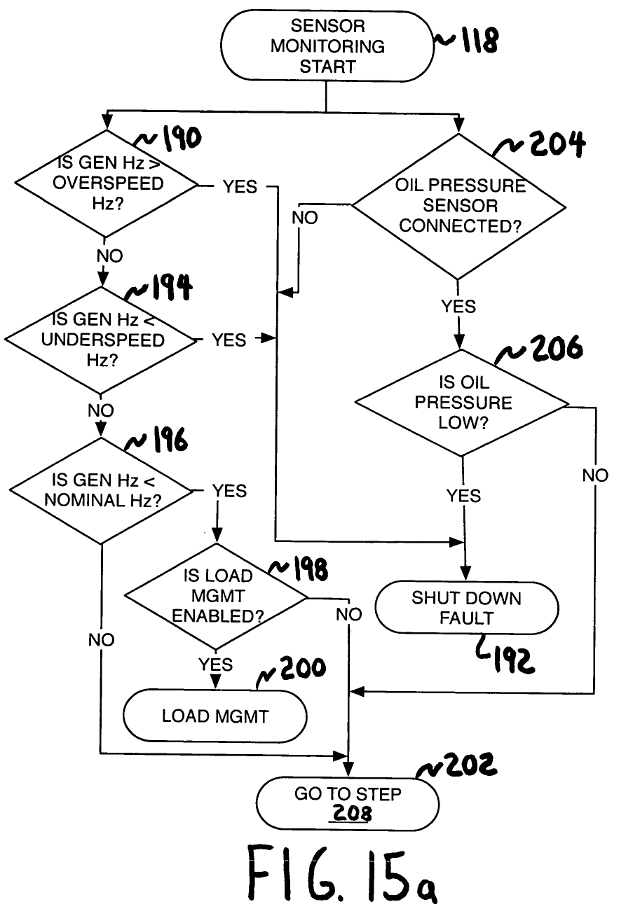

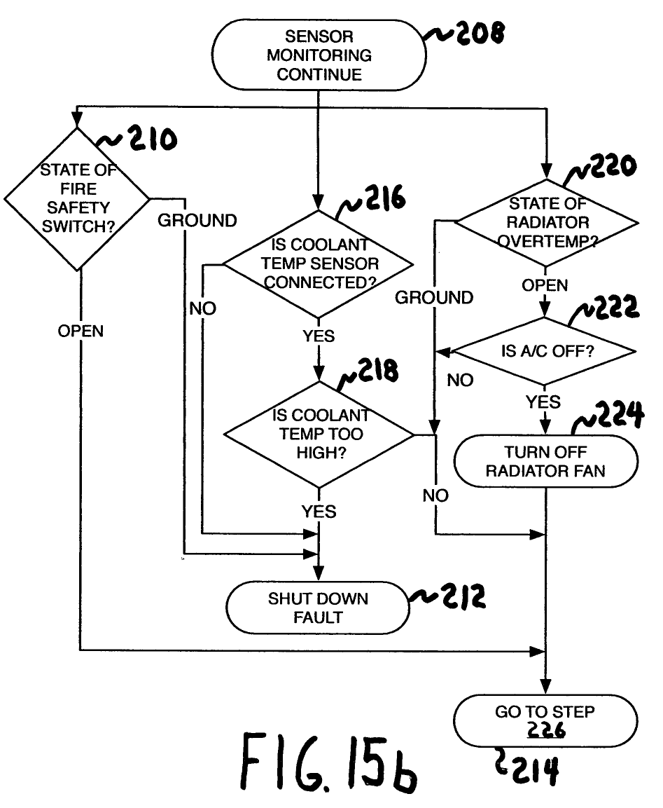

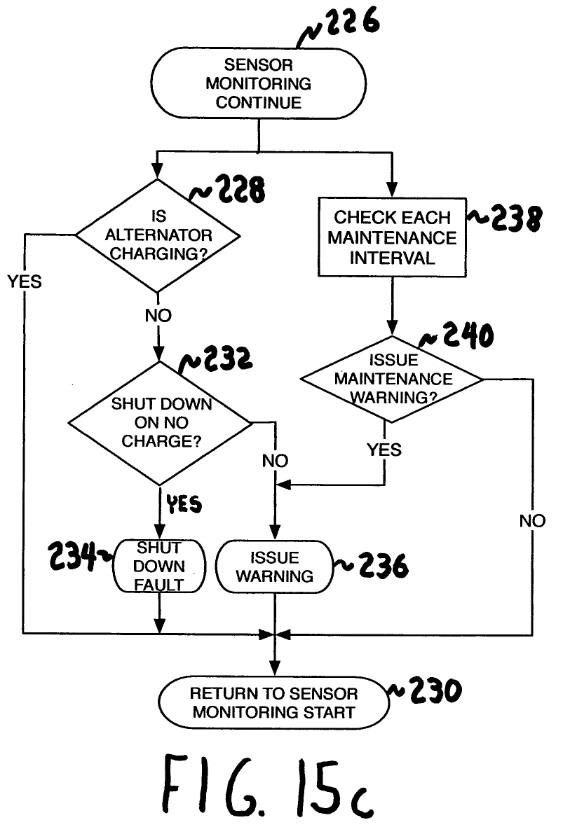

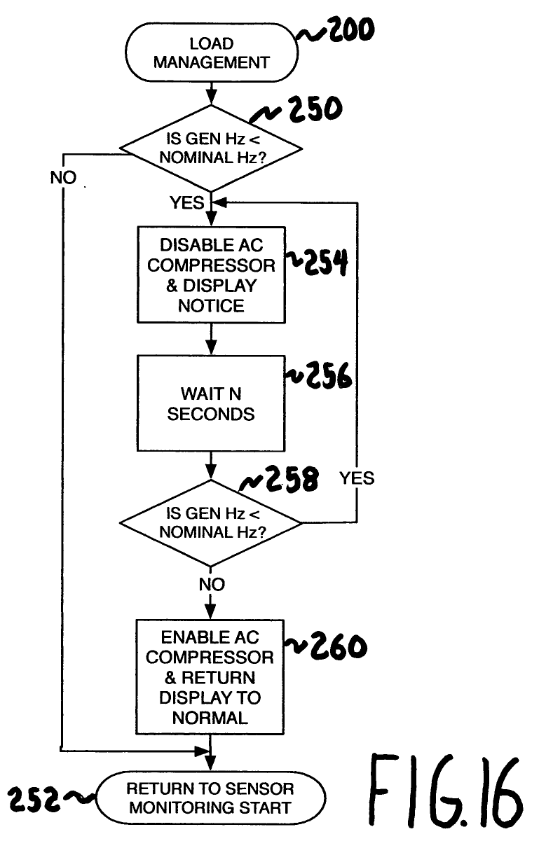

In addition to monitoring the battery voltage conditions, the ECU 80 also monitors many other sensors and systems of the APU 10 during its operation. For example, FIGS. 15a through 15c illustrate the operation of the FET sensor monitoring thread or subroutine, step 118, referenced in FIG. 11. From step 118, the ECU would initiate a number of different threads, including one thread for monitoring the AC power generator 30 and a second thread for monitoring oil pressure within the APU engine 12. In step 190, the ECU first seeks to determine if the frequency of power being generated by the generator 30 exceeds a predetermined maximum frequency called “overspeed Hz.” The frequency of the AC power generator is being monitored to determine if the APU engine 12 is being overtaxed or malfunctioning. If the frequency is too high, this is a sign that the generator 30 might be malfunctioning, so the ECU will shut the APU 10 down, step 192, until the fault can be evaluated.

Likewise, if the frequency is too low, below the “underspeed Hz,” step 194, the generator 30 might be malfunctioning in a different way, so the ECU will again shut the APU 10 down, step 192, until the fault can be evaluated. If the frequency of the generator 30 is neither too high nor too low, the ECU will nevertheless check to see if the frequency of the generator has not dropped below a nominal operating frequency, step 196. The most likely cause of the frequency of the generator 30 dropping below the nominal frequency is too many electrical systems drawing power from the generator 30 at the same time and taxing the APU engine 12. When this occurs, the ECU will check to see if load management is enabled, step 198, and if so, the ECU will initiate the load management subroutine, step 200, which is further illustrated with reference to FIG. 16 below. If the generator 30 frequency is within the nominal range or load management is not enabled, the ECU will continue the subroutine, step 202.

The ECU initiates the process of monitoring the oil pressure of the APU engine 12 by checking to make sure the oil pressure sensor is connected or operational, step 204, and shutting the APU 10 down if it is not, step 192. If the oil pressure sensor is connected, then the ECU will check to see if the oil pressure is low, step 206. If the oil pressure is low, the ECU shuts the APU 10 down, but if it is not, the subroutine continues, step 202, to the next stages of the thread, step 208.

In this next stage of the sensor monitoring thread, illustrated in FIG. 15b, three different sensors are monitored. The first sensor monitored is the fire safety switch, step 210. If the safety switch is grounded, then the ECU 80 will shut the APU 10 down, step 212. If the safety switch is open, then the ECU moves on to the next stage of the thread, step 214. The second sensor monitored is the coolant temperature sensor. If the coolant temperature sensor is connected, step 216, the ECU 80 will test to see if the coolant temperature is too high, step 218. If the coolant temperature sensor is either disconnected or inoperable or the coolant temperature is too high, the ECU 80 will shut the APU 10 down, step 212. If the coolant temperature is acceptable, the ECU 80 moves on to the next stage of the thread, step 214.

The next sensors monitored relate to the radiator 18. If the radiator overtemp sensor is grounded, step 220, then the ECU will move on to the next stage of the thread, step 214. If the radiator overtemp sensor is open, step 220, however, the ECU 80 will check to see if the air conditioning is off, step 222, and if it is, the ECU will turn off the radiator fan, step 224, before continuing, step 214, to the next stages of the thread, step 226.

In FIG. 15c, the thread continues, step 226, to check additional sensors and systems. If the alternator is charging, step 228, the thread will restart at step 118, via step 230. If the alternator is not charging, then the ECU will check to see if the system is set to shut down when there is no charge from the alternator, step 232, and if so, shut the APU 10 down, step 234. If not, then the ECU will just issue a warning that the alternator is not charging, step 236. In addition to checking certain key sensors, the thread also checks the status of each maintenance interval, such as oil changes, step 238, and issues a warning, step 240, should the ECU be programmed to issue warnings for the appropriate maintenance check. It should be noted that for purposes of simplifying the drawing in FIG. 15c, steps 238 and 240 only represent a single maintenance check, but would in fact be repeated for each and every maintenance check that might be performed. Once all of the maintenance checks had been performed, and warnings issued as necessary, the thread would start over again at step 118.

As noted with respect to FIG. 15a, when the AC power generator's frequency drops below a predetermined nominal frequency, and load management is enabled, the ECU 80 will enter a load management subroutine, step 200. As illustrated in FIG. 16, the ECU 80 will first retest the frequency of the generator 30 to see if the frequency is still below the nominal frequency level, step 250. If the frequency of the AC power generator 30 has returned to at least a nominal level, then the ECU will return to the start of the sensor monitoring thread, step 252. If the frequency of the generator 30 is still below the nominal frequency level at step 250, then the ECU 80 will disable the air conditioning compressor 28 in step 254. The point behind this action is that the air conditioning compressor 28 creates the single largest draw on the power of the APU engine 12 and thereby reduces the power available from the AC power generator 30 when it is enabled.

Most of the time, the power drawn from the generator 30 by the air conditioning compressor is not an issue and does not cause the frequency of the generator 30 to drop below a nominal level, but if the driver attempts to run one or more electrical devices in the cabin at the same time that also draw large amounts of power, such as a microwave, it can present issues. Rather than shift the responsibility to the driver to anticipate the problem and turn off the air conditioning before using other electrical devices, the ECU 80 senses the power disruption caused by the additional electrical device and immediately disables the air conditioning compressor to free up additional power from the generator. Once the compressor has been disabled, the ECU 80 needs to figure out when to enable it again so as to not adversely affect the driver's comfort within the cabin. Hence, the ECU will wait a predetermined period of time, N seconds, step 256, before retesting the frequency from the generator, step 258. If the additional draw has stopped and the frequency has returned to a nominal level, the ECU 80 will enable the air conditioning compressor, step 260. Otherwise, the subroutine will return to step 254 and continue to test the system.

Additional load management features include the partial disablement of the air conditioning compressor, so as to lessen the effect of turning it off completely, and some form of electronic throttle control that would enable the engine to run at a higher speed when more power is needed.

The present invention, while illustrated and described in terms of a preferred embodiment and several alternatives, is not limited to the particular description contained in this specification. Additional alternative or equivalent components and steps could be used to practice the present invention.

1. An alternative power unit mounted to a vehicle having a battery for use in combination with or in place of a main engine of said vehicle, for providing AC and DC power to one or more areas of said vehicle, and for providing HVAC services for said vehicle when said main engine is not in use, comprising:
an engine having sufficient power to power said areas, including one or more of the following, a DC power alternator, an AC power generator, an air conditioning compressor, and a coolant-based radiator;
a frame for mounting said engine to said vehicle, said frame including a sliding component for readily moving said engine away from said vehicle for service and maintenance;
a HVAC system within a human occupied area of said vehicle;
an engine control unit having a programmable processor; and
a user interface for controlling said engine control unit.

2. The power unit as recited in claim 1, wherein said main engine and said engine utilize the same type of fuel and share a common fuel tank.

3. The power unit as recited in claim 1, wherein said engine further includes a condenser and fan unit that can be mounted to said frame or mounted to a portion of said vehicle remote from said human occupied area.

4. The power unit as recited in claim 1, wherein said frame is mounted directly to a frame rail of said vehicle.

5. The power unit as recited in claim 1, wherein said frame is mounted indirectly to a frame rail of said vehicle through use of one or more brackets connected to said frame and said frame rail.

6. The power unit as recited in claim 1, wherein said HVAC system supplies heat to said human occupied area of said vehicle through use of said coolant-based radiator.

7. The power unit as recited in claim 1, wherein said HVAC system supplies air conditioning to said human occupied area of said vehicle through use of said aid conditioning compressor.

8. The power unit as recited in claim 1, wherein said engine control unit controls the provision of DC power to said battery of said vehicle through use of said DC power alternator.

9. The power unit as recited in claim 1, wherein power wires and communication wires are connected from said power unit to said human occupied area of said vehicle through a spring-shaped umbilical cord.

10. The power unit as recited in claim 1, wherein said engine is connected to an exhaust pipe by a flexible metal hose and a quick fit connector to facilitate movement of said engine away from said vehicle.

11. The power unit as recited in claim 1, wherein said engine is covered by a detachable environmental shell.

12. The power unit as recited in claim 11, wherein said detachable environmental shell includes one or more steps on an outer facing side for aiding a human's access to said vehicle.

13. The power unit as recited in claim 11, wherein said detachable environmental shell includes a decorative outer surface.

14. The power unit as recited in claim 11, wherein said detachable environmental shell includes a ventilation panel for enabling air to pass to and from said engine.

15. The power unit as recited in claim 1, wherein said user interface is located in said human occupied area of said vehicle.

16. The power unit as recited in claim 1, wherein said user interface includes a computer interface for direct or remote connection of a computer to said engine control unit for operation, control, monitoring, or modification of said engine control unit.

17. The power unit as recited in claim 1, wherein said user interface includes a wireless connection for remote connection of a computer to said engine control unit for operation, control, monitoring, or modification of said engine control unit.

18. The power unit as recited in claim 1, wherein said engine control unit provides different levels of user control.

19. The power unit as recited in claim 18, wherein said different levels of user control correlate with different levels of access, through different user names and passwords, to said engine control unit such that a vehicle driver, an operator, an owner, a manufacturer or a service provider each have a desired level of access.

20. The power unit as recited in claim 1, wherein said engine control unit terminates power to said main engine after said main engine has idled for a predetermined period of time and activates said engine.

21. The power unit as recited in claim 1, wherein said engine control unit includes a thermostatic temperature control unit for controlling a temperature within said human occupied area of said vehicle.

22. The power unit as recited in claim 6, wherein said coolant-based radiator has an electric heater inside a radiator coolant hose connecting said coolant-based radiator to said engine.

23. The power unit as recited in claim 1, wherein said user interface includes a series of controllers, a speaker, and a display panel.

24. The power unit as recited in claim 1, wherein said engine control unit is operative to sense a change in input power from either said DC power alternator or said AC power generator and to change an operating power and frequency power requirement for said engine control unit accordingly.

25. The power unit as recited in claim 1, wherein said engine control unit includes a real time clock for displaying a time on said user interface and operating in conjunction with said engine control unit to create a time stamped log and track usage of said engine.

26. The power unit as recited in claim 1, wherein said engine control unit is operative to receive power from a back up battery source.

27. The power unit as recited in claim 1, wherein said engine control unit is operative to disable or decrease power to said air conditioning compressor when an operating frequency for said AC power generator drops below a nominal level.

28. A method for conveying information regarding an auxiliary power unit to a user through a user interface, comprising the steps of:
collecting data indicating operating conditions of said auxiliary power unit; and
outputting said data on a display of said user interface through a number of display steps including displaying current information about said auxiliary power unit, displaying a time and a date, and displaying action information.

29. The method as recited in claim 28, wherein said current information includes a number of hours said auxiliary power unit ran since last serviced, a current coolant temperature, an oil pressure, and a generator voltage and frequency.

30. The method as recited in claim 28, wherein said action information includes a warning signal and a required maintenance.

31. The method as recited in claim 28, wherein said step of outputting said data includes the step of toggling between said number of display steps in response to a button on said user interface being pushed by said user.

32. The method as recited in claim 28, wherein said step of outputting said data includes the step of toggling between said number of display steps after a predetermined time.

33. A frame assembly for mounting an auxiliary power unit to a vehicle, comprising:
a frame including a sliding component for readily moving said auxiliary power unit away from said vehicle for service and maintenance; and
a locking mechanism for said sliding component to prevent movement of said auxiliary power unit during operation of said vehicle.

34. The frame assembly as recited in claim 33, wherein said locking mechanism includes fixable bolts connected to a front of said auxiliary power unit.

35. The frame assembly as recited in claim 33, wherein said frame includes a stationary mounting frame connected to said vehicle and wherein said sliding component includes rollers affixed to said sliding component that travel along said stationary mounting frame.

36. The frame assembly as recited in claim 33, wherein said auxiliary power unit includes power wires and communication wires that are connected to a human occupied area of said vehicle by a spring-shaped umbilical cord that expands and contracts as said sliding component travels away from and to said vehicle, respectively.

37. The frame assembly as recited in claim 33, wherein said auxiliary power unit includes an exhaust pipe of that is connected to said auxiliary power unit with a flexible metal hose and a quick fit connector.

38. The frame assembly as recited in claim 33, wherein said auxiliary power unit is covered by a detachable environmental shell.

39. The frame assembly as recited in claim 38, wherein said detachable environmental shell includes one or more steps on an outer facing side for aiding a human's access to said vehicle.

40. The power unit as recited in claim 38, wherein said detachable environmental shell includes a decorative outer surface.

41. The power unit as recited in claim 38, wherein said detachable environmental shell includes a ventilation panel for enabling air to pass to and from said auxiliary power unit.

42. A control system for an auxiliary power unit mounted to a vehicle, having a vehicle engine, comprising:
an engine control unit having a programmable processor for controlling said auxiliary power unit;
a user interface for controlling said engine control unit; and
a computer interface for direct or remote connection of a computer to said engine control unit for operation, control, monitoring, or modification of said engine control unit.

43. The control system as recited in claim 42, wherein said user interface is located in a human occupied area of said vehicle.

44. The control system as recited in claim 42, wherein said engine control unit provides different levels of user control.

45. The control system as recited in claim 44, wherein said different levels of user control correlate with different levels of access, through different user names and passwords, to said engine control unit such that a vehicle driver, an operator, an owner, a manufacturer or a service provider each have a desired level of access.

46. The control system as recited in claim 42, wherein said engine control unit terminates power to said vehicle engine after said vehicle engine has idled for a predetermined period of time and activates said auxiliary power unit.

47. The control system as recited in claim 42, wherein said user interface includes a series of controllers, a speaker, and a display panel.

48. The control system as recited in claim 42, wherein said engine control unit is operative to sense a change in input power from one or more electrical power sources of said auxiliary power unit and change an operating power and a frequency power requirement for said engine control unit accordingly.

49. The control system as recited in claim 42, wherein said engine control unit includes a real time clock for displaying a time on said user interface and operating in conjunction with said engine control unit to create a time stamped log and track usage of said engine.

50. The control system as recited in claim 42, wherein said engine control unit is operative to receive power from a back up battery source.

51. A control system for an auxiliary power unit mounted to a vehicle, having a vehicle engine, comprising:
an engine control unit having a programmable processor for controlling said auxiliary power unit;
a user interface for controlling said engine control unit; and
a wireless connection for remote connection of a computer to said engine control unit for operation, control, monitoring, or modification of said engine control unit.

52. The control system as recited in claim 51, wherein said user interface is located in a human occupied area of said vehicle.

53. The control system as recited in claim 51, wherein said engine control unit provides different levels of user control.

54. The control system as recited in claim 51, wherein said different levels of user control correlate with different levels of access, through different user names and passwords, to said engine control unit such that a vehicle driver, an operator, an owner, a manufacturer or a service provider each have a desired level of access.

55. The control system as recited in claim 51, wherein said engine control unit terminates power to said vehicle engine after said vehicle engine has idled for a predetermined period of time and activates said auxiliary power unit.

56. The control system as recited in claim 51, wherein said user interface includes a series of controllers, a speaker, and a display panel.

57. The control system as recited in claim 51, wherein said engine control unit is operative to sense a change in input power from one or more electrical power sources of said auxiliary power unit and to change an operating power and a frequency power requirement for said engine control unit accordingly.

58. The control system as recited in claim 51, wherein said engine control unit includes a real time clock for displaying a time on said user interface and operating in conjunction with said engine control unit to create a time stamped log and track usage of said engine.

59. The control system as recited in claim 51, wherein said engine control unit is operative to receive power from a back up battery source.

60. An apparatus for mounting an auxiliary power unit to a frame rail of a vehicle comprising:
a pair of brackets affixed to said frame rail of said vehicle; and
a frame assembly affixed to said pair of brackets and to said auxiliary power unit.

61. The apparatus as recited in claim 60, wherein said frame includes a sliding component for readily moving said auxiliary power unit away from said vehicle for service and maintenance.

62. The apparatus as recited in claim 60, wherein each of said pair of brackets includes a back component and a front component, said back component being affixed to said front component around said frame rail without altering the integrity of said frame rail.

63. The apparatus as recited in claim 60, wherein each of said pair of brackets is affixed to said frame rail by at least two fastenable bolts passed through holes in said frame rail and said bracket, and wherein each of said pair of brackets is affixed to said frame assembly by at least two fastenable bolts passed through holes in said frame assembly and said bracket.

64. The apparatus as recited in claim 63, wherein said holes in said frame rail are pre-drilled by a manufacturer of said vehicle.

65. An auxiliary power unit mounted to a vehicle, having a vehicle engine, for providing HVAC services for said vehicle, comprising:
a HVAC system passive to said vehicle engine for providing air conditioning and heating to a human occupied area of said vehicle; and
a movable condenser and fan unit that functions in cooperation with said HVAC system, said condenser and fan unit being operative to be mounted to said auxiliary power unit or to a portion of said vehicle remote from said human occupied area.

66. An auxiliary power unit mounted to a vehicle, having a vehicle engine, for providing HVAC services for said vehicle, comprising:
a HVAC system passive to said vehicle engine for providing air conditioning and heating to a human occupied area of said vehicle;
an engine control unit having a programmable processor for controlling said HVAC system;
a user interface for controlling said engine control unit; and
a thermostatic temperature control unit for controlling a temperature within said human occupied area of said vehicle.

67. An auxiliary power unit mounted to a vehicle for providing HVAC services for said vehicle, comprising:
a battery for supplying starting power to said auxiliary power unit;
an engine passive to a main engine of said vehicle for providing auxiliary power, said engine including one or more of the following, a DC power alternator, an AC power generator, an air conditioning compressor, and a coolant-based radiator;
a HVAC system passive to said main engine and powered by said auxiliary power unit for providing air conditioning and heating to a human occupied area of said vehicle;
an engine control unit having a programmable processor for controlling said engine and said HVAC system, said engine control unit being operative to disable or decrease power to said air conditioning compressor when an operating frequency for said AC power generator drops below a nominal level; and
a user interface for controlling said engine control unit.

68. The auxiliary power unit of claim 67, wherein said engine control unit is operative to switch said battery to supply said starting power to said main engine.

69. An auxiliary power unit mounted to a vehicle comprising:
an engine passive to a main engine of said vehicle for providing power for use by said vehicle; and
an exhaust pipe, connected to said engine by a flexible metal hose and a quick fit connector to facilitate movement of said engine away from said vehicle.
